(19) United States
(12) Patent Application Publication
(10) Pub. No.: US 2026/0346167 A1
(43) Pub. Date: Nov. 5, 2026

(54) FLUID FILTER MODULE

(71) Applicant: MAHLE International GmbH, Stuttgart (DE)

(72) Inventor: Lovro Plazl, St. Michael ob Bleiburg (AT)

(21) Appl. No.: 19/194,897

(22) Filed: Apr. 30, 2025

(51) Int. Cl. B01D 29/11; B01D 35/00

(52) U.S. Cl. CPC B01D 29/114; B01D 35/005; B01D 2201/295; B01D 2201/305; B01D 2201/316; B01D 2201/342

(57) ABSTRACT

A filter element may include a support structure, a filter material, and a sealing disc. The support structure may include a first endplate having a first endplate opening, a second endplate having a second endplate opening, and an axial passageway extending between the first endplate and the second endplate. The first endplate opening, the second endplate opening, and the axial passageway may be at least partially aligned with one another in an axial direction. The filter material may be arranged on the support structure between the first endplate and the second endplate. The sealing disc may be arranged on the first endplate and may at least partially cover the first endplate opening.

### TECHNICAL FIELD

The present disclosure generally relates to fluid filter modules that may, for example, be used in connection with internal combustion engines and/or motor vehicles, and filters and/or filter elements of such fluid filter modules.

### BACKGROUND

Fluid filter modules can be found in any motor vehicle that includes an internal combustion engine, and serve for filtering out different contaminants from the fuel. Contaminants may include solid particulates and/or water, as examples.

Particulates, for instance, can be introduced into the fuel stream in a variety of ways, such as dirt or rust while filling the tank, or from the fuel itself if from an unfiltered source. Particulates can be abrasive and can cause rapid wear and failure of engine components, such as the fuel pump and injectors. Fluid filter modules therefore typically include a particulate filter material (e.g., paper), which allows the through passage of fuel (and any water present), while capturing the particulate matter. In at least some designs, the particulate filter material is formed as part of a filter element that is arranged in a housing.

Over time the filter material may become clogged with particulate, which can result in decreased engine performance. As such, filter elements are typically changed at regular intervals during the life of the engine as routine maintenance. However, the engine can be inadvertently damaged during a routine changing of the filter element if the filter element is not installed properly.

For instance, careless installation may include pressing down on and/or exerting excessive force on the filter element, which can put pressure on and potentially break one or more components of the filter module. As another example, if components of the filter element and the housing are not properly aligned (e.g., in an axial direction), tolerance stack-ups may result in improper axial location of components and/or improper sealing or fitting between mating components of the filter element and the housing. Misalignment of the filter element and the housing during installation can also result in one or more components of the filter element, such as a sealing ring utilized and/or needed to form a fluid tight seal between two plastic components, becoming jammed and/or damaged. An angular misalignment of the filter element can cause the filter element to bind up within the housing and cause damage.

Some filter module designs include insertion and/or positioning guides to aid in the insertion of the filter element into the housing. The insertion and/or positioning guides, however, can themselves become bound up and/or snap off if the filter element and the housing are not properly aligned during insertion. Such a breakage can ruin the filter element and potentially result in a fractured and/or broken off piece of the filter element being left behind within the housing and falling into an inaccessible region of the housing and/or becoming lodged in housing. Worse yet, the fractured and/or broken off piece of the filter element may become lodged within and/or obstruct a fluid channel and/or passage of the housing and/or the filter module, which can require costly engine repairs to remedy.

Accordingly, there is a need for an improved fluid filter module that minimizes or eliminates one or more challenges or shortcomings of existing fluid filter modules.

### SUMMARY

Pursuant to an implementation, a filter element may comprise a support structure, a filter material, and a sealing disc. The support structure may include a first endplate having a first endplate opening, a second endplate having a second endplate opening, and an axial passageway extending between the first endplate and the second endplate. The first endplate opening, the second endplate opening, and the axial passageway may be at least partially aligned with one another in an axial direction. The filter material may be arranged on the support structure between the first endplate and the second endplate. The sealing disc may be arranged on the first endplate and may at least partially cover the first endplate opening.

Pursuant to an implementation, a filter element may comprise a support structure, a filter material, and a fleece sealing disc. The support structure may include a first endplate, a second endplate, and an interior tube extending between and connecting the first endplate and the second endplate. The first endplate may include a first endplate opening configured to receive a standpipe of a cover of a filter housing. The first endplate may further include a plurality of latches via which the support structure is releasably connectable to the cover of the filter housing. The second endplate may include a second endplate opening and a tubular extension configured to be received in and sealingly engage an annular collar of a housing base of the filter housing. The interior tube may define an axial passageway extending between the first endplate and the second endplate. The filter material may be arranged on the support structure between the first endplate and the second endplate, and may extend circumferentially around the interior tube. The fleece sealing disc may be arranged on and connected to the first endplate. The fleece sealing disc may have a disc opening configured to receive the standpipe of the filter housing when the support structure is connected to the cover. The fleece sealing disc may be deformable via the standpipe such that, when the support structure is connected to the cover, a deformed portion of the fleece sealing disc extends axially and is disposed radially between and in sealing contact with the first endplate and the standpipe.

Various other features and advantages will be made apparent from the following detailed description and the drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIGS. 1 and 2 are perspective views of an exemplary filter element;

FIG. 3 is a cross-sectional perspective view of the filter element of FIG. 1;

FIG. 4A is a close-up cross-sectional perspective view of the filter element of FIG. 1;

FIG. 4B is a close-up cross-sectional perspective view of the filter element of FIG. 1 with the fleece sealing disc hidden/removed;

FIGS. 5A, 5B, 6A, and 6B illustrate a method and/or process of assembling a fluid filter module and/or of installing the filter element of FIG. 1 in a filter housing;

FIGS. 5A and 5B illustrate a method and/or process of connecting the filter element of FIG. 1 to a cover of the filter housing (e.g., during installation of the filter element in the filter housing);

FIGS. 6A and 6B illustrate a method and/or process of connecting the filter element of FIG. 1 to a housing base of the filter housing (e.g., during installation of the filter element in the filter housing);

FIG. 7 is a front view of the filter element of FIG. 1;

FIG. 8 is a back view of the filter element of FIG. 1;

FIG. 9 is a right-side view of the filter element of FIG. 1;

FIG. 10 is a left-side view of the filter element of FIG. 1;

FIG. 11 is a top view of the filter element of FIG. 1;

FIG. 12 is a bottom view of the filter element of FIG. 1;

FIG. 13 is a partially exploded perspective view of a portion of the filter element of FIG. 1;

FIG. 14 is a top view of the filter element of FIG. 1 with the fleece sealing disc removed/hidden;

FIG. 15 is a front view of the filter element of FIG. 1 with a transparent depiction of the filter material to provide an unobstructed view of the support structure and/or the interior tube thereof;

FIG. 16 is a back view of the filter element of FIG. 1 with a transparent depiction of the filter material to provide an unobstructed view of the support structure and/or the interior tube thereof;

FIG. 17 is a right-side view of the filter element of FIG. 1 with a transparent depiction of the filter material to provide an unobstructed view of the support structure and/or the interior tube thereof; and

FIG. 18 is a left-side view of the filter element of FIG. 1 with a transparent depiction of the filter material to provide an unobstructed view of the support structure and/or the interior tube thereof.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Disclosed is a fluid filter module 10 for a motor vehicle (e.g., an automobile) and/or an engine assembly thereof. The fluid filter module 10 includes a filter element 200 and a filter housing 100 that encloses the filter element 200. The module 10 and/or the filter element 200 thereof is configured to filter a fluid (e.g., fuel, oil, lubricant), such as by collecting, removing, and/or filtering out contaminants from the fluid. The filter module 10, such as a raw side and/or a fluid inlet thereof, is connectable to one or more other components that supply and/or convey raw and/or dirty fluid (e.g., fuel, oil, lubricant) to the module 10. The filter module 10, such as a clean side and/or an outlet thereof, is connectable to one or more other components that receive clean and/or filtered fluid from the module 10. In the illustrative example herein, the outlet of the fluid filter module 10 is formed and/or defined by the collar 160 of the housing base 150 and/or the tubular extension 266 of the filter element 200. During operation, raw and/or dirty fluid flows through the fluid inlet (not illustrated) of the module 10 and/or housing 100 into a raw fluid space surrounding the filter element 200, passes through the filter material 206 (e.g., in a radially inward direction) into the axial passageway 212 (i.e., a clean fluid space) via apertures 214 of the interior tube 210, and then flows through the axial passageway 212 (e.g., in an axial direction toward the housing base 150 and/or second endplate 260) to the tubular extension 266, the annular collar 160, and/or the outlet where it is discharged from the fluid filter module 10 and/or filter housing 100. The raw fluid is filtered (e.g., impurities contained in the fluid are removed and/or collected) by the filter element 200 (e.g., the filter material 206) as the fluid passes and/or flows through the filter element 200 and/or the filter material 206 from the raw fluid space to the axial passageway 212 and/or clean fluid space.

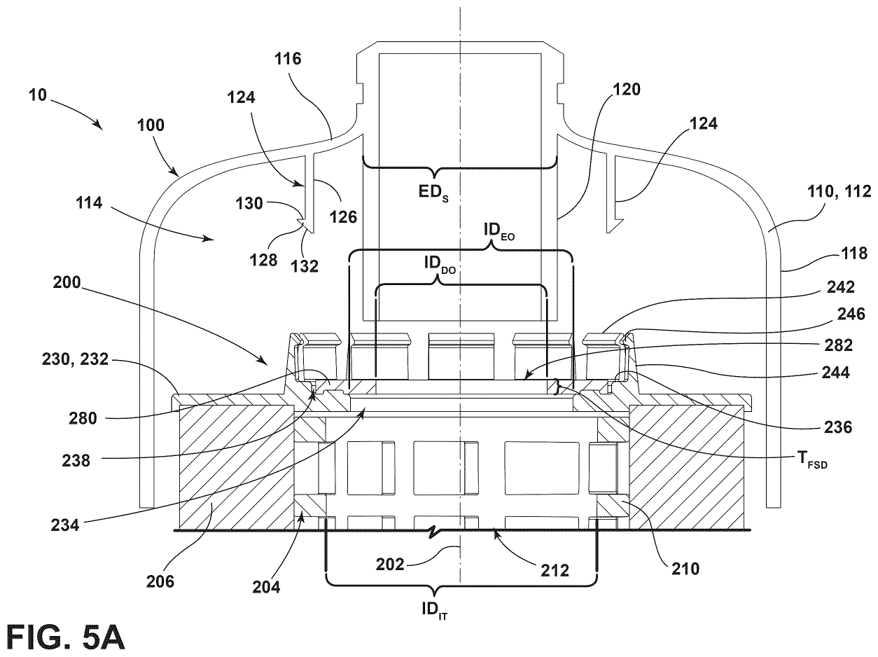

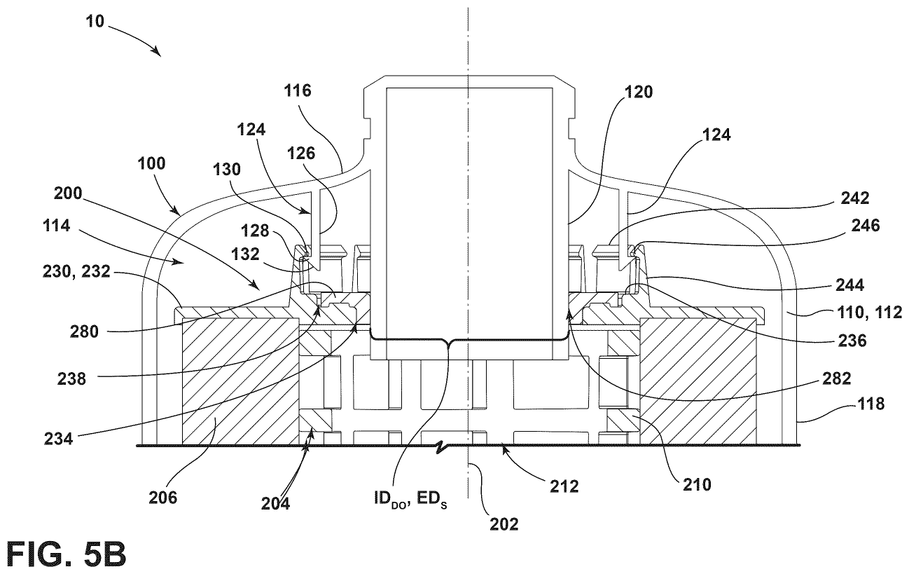

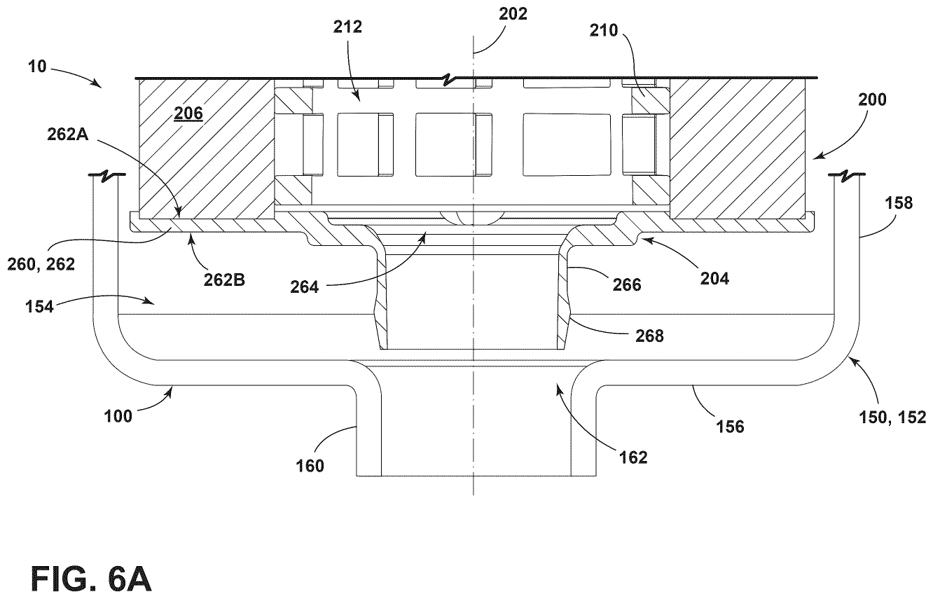

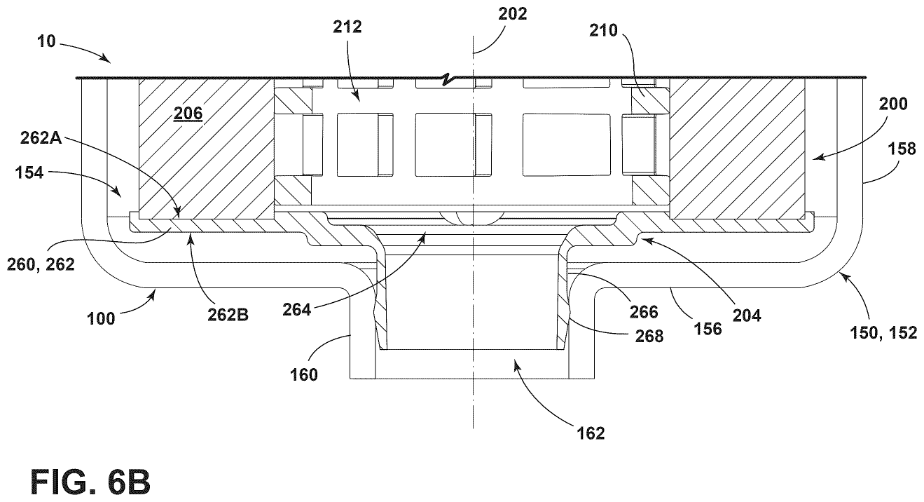

The filter housing 100 receives and encloses the filter element 200. The filter housing 100 includes a cover 110 and a housing base 150 as generally illustrated in FIGS. 5A-6B. The filter housing 100 and/or the components thereof (e.g., the cover 110 and/or the housing base 150) are typically composed of plastic, but other material compositions are conceivable. The cover 110 and the housing base 150 are releasably connectable to one another, such as via complimentary threads, and may collectively form and/or define the filter housing 100. The cover 110 is releasably connectable to the filter element 200, such as via a plurality of mating formations 124 that releasably engage complimentary latches 242 of the filter element 200. During assembly of the module 10, the cover 110 may be connected to the filter element 200 (e.g., to form and/or define a subassembly including the cover 110 and the filter element 200) and the filter element 200 of the subassembly subsequently connected to the housing base 150.

As generally illustrated in FIGS. 5A and 5B, the cover 110 is generally cup-shaped body 112 defining a cavity 114. The cover 110 and/or the body 112 thereof includes a bottom 116 and one or more sidewalls 118 projecting therefrom. The bottom 116 and the sidewall 118 at least partially define the cavity 114, which receives fluid (e.g., the raw fluid and/or air) and/or at least a portion of the filter element 200. The bottom 116 forms and/or defines a closed end of the cover 110. The sidewall 118 is connected to the bottom 116, extends around an outer perimeter of the bottom 116 (e.g., in a circumferential direction), and projects transversely (e.g., obliquely and/or perpendicularly) from the bottom 116, such as in the axial direction. The sidewall 118 may therefore also be considered, referred to, and/or claimed as an outer sidewall, a perimeter sidewall, and/or an outer perimeter sidewall. While the cover 110 includes a singular tube-shaped and/or cylindrical sidewall 118 having a circular profile in the illustrative example herein, the cover 110 could conceivably include a plurality of sidewalls and/or have a profile with a variety of other shapes (e.g., a elliptical profile, a plurality of planar sidewalls that define a triangular and polygonal profile). The free end of the sidewall 118 opposite the bottom 116 may form and/or define an open end of the cover 110 and is connectable to the housing base 150. In some examples, the sidewall 118 includes threads (e.g., radially inward or outward projecting helical threads) that engage complimentary threads of the housing base 150 to releasably connect the cover 110 and the housing base 150.

The cover 110 includes a standpipe 120 configured to be inserted into and engage the fleece sealing disc 280 of the filter element 200 to provide and/or establish a fluid tight seal between the cover 110 (e.g., the standpipe 120) and the support structure 204 (e.g., the first endplate 230 and/or the interior tube 210). The standpipe 120 is a hollow, elongated, annular body that projects from the bottom 116 and/or body 112 of the cover 110 (e.g., transversely, obliquely, and/or perpendicularly to the bottom 116, and/or generally in the axial direction). An external diameter ED_{S} of the standpipe 120 is greater than an internal diameter of the disc opening 282 ID_{DO} of the fleece sealing disc 280.

As illustrated in FIG. 5B, when the cover 110 and the filter element 200 are connected, the standpipe 120 projects through the disc opening 282 and the first endplate opening 234 into the axial passageway 212. The fleece sealing disc 280 is deformed by the standpipe 120 such that at least a portion of the fleece sealing disc 280 projects into the first endplate opening 234, the axial passageway 212, and/or the interior tube 210, and that now axially extending portion of the fleece sealing disc 280 is disposed radially between, compressed by, and in sealing contact with the standpipe 120 of the cover 110 and the support structure 204 (e.g., the first endplate 230 and/or the interior tube 210) of the filter element 200.

The cover 110 further includes a plurality of mating formations 124 configured to releasably engage the latches 242 of the filter element 200. The mating formations 124 each contact and/or engage a respective latch 242 of the filter element 200 to connect, attach, couple, fasten, and/or secure the cover 110 and the filter element 200 together. The mating formations 124 are disposed on and project transversely (e.g., obliquely or perpendicularly) from the bottom 116 of the cover 110 toward the filter element 200 (e.g., generally in the axial direction). Optionally, a mating formation 124 is configured to elastically deform and/or to be deflected radially inward (e.g., toward the central longitudinal axis 202), such as via a sloped surface 250 of a respective latch 242 when inserting the filter element 200 into the cover 110. Optionally, a mating formation 124 may also be configured to return to an undeflected position when a portion of the latch 242 (e.g., the stop surface 248 thereof) passes a portion of the mating formation 124 (e.g., the stop surface 130 thereof) such that the latch 242 transitions (e.g., from contacting a sloped surface 132 of the mating formation 124) to contacting the stop surface 130 of the mating formation 124.

The mating formations 124 are structured as latches in the illustrative example herein, but may be structured and/or configured differently (e.g., as recesses, protrusions, or tabs) in other examples. The mating formations 124 of the cover 110 may thus be considered, referred to, and/or claimed as cover latches to distinguish and/or differentiate from the latches 242 of the filter element 200, which may also be referred to as filter latches 242 for this same purpose.

The mating formations 124 each include an elongated projection 126 and a tab 128. The projection 126 is disposed on and projects transversely (e.g., obliquely or perpendicularly) from the bottom 116 of the cover 110 toward the filter element 200 (e.g., generally in the axial direction). The tab 128 projects radially outward from the projection 126, such as at, about, and/or adjacent to a free end of the projection 126. The tab 128 includes a stop surface 130 that faces generally toward the bottom 116 of the cover 110. Optionally, the tab 128 also includes a sloped and/or inclined surface 132 that may, for example, facilitate elastic deformation and/or deflection of the mating formation 124 and/or the latch 242.

As generally illustrated in FIGS. 6A and 6B, the housing base 150 is generally cup-shaped body 152 defining a cavity 154. The housing base 150 and/or the body 152 thereof includes a bottom 156 and one or more sidewalls 158 projecting therefrom. The bottom 156 and the sidewall 158 at least partially define the cavity 154, which receives fluid (e.g., the raw fluid) and/or at least a portion of the filter element 200. The bottom 156 forms and/or defines a closed end of the housing base 150. The sidewall 158 is connected to the bottom 156, extends around an outer perimeter of the bottom 156 (e.g., in a circumferential direction), and projects transversely (e.g., obliquely and/or perpendicularly) from the bottom 156, such as in the axial direction. The sidewall 158 may therefore also be considered, referred to, and/or claimed as an outer sidewall, a perimeter sidewall, and/or an outer perimeter sidewall. While the housing base 150 includes a singular tube-shaped and/or cylindrical sidewall 158 having a circular profile in the illustrative example herein, the housing base 150 could conceivably include a plurality of sidewalls and/or have a profile with a variety of other shapes (e.g., a elliptical profile, a plurality of planar sidewalls that define a triangular and polygonal profile). The free end of the sidewall 158 opposite the bottom 156 may form and/or define an open end of the housing base 150 and is connectable to the cover 110. In some examples, the sidewall 158 includes threads (e.g., radially inward or outward projecting helical threads) that engage complimentary threads of the cover 110 to releasably connect the cover 110 and the housing base 150.

The housing base 150 includes an annular collar 160 configured to receive and engage the tubular extension 266 of the second endplate 260 of the filter element 200. The collar 160 is an annular projection that extends and/or protrudes transversely (e.g., perpendicularly and/or obliquely) from the bottom 156 and/or body 152 of the housing base 150 (e.g., transversely, obliquely, and/or perpendicularly to the bottom 156, and/or generally in the axial direction). The collar 160 also extends around a recess 162 of the housing base 150 (e.g., generally in the circumferential direction). The collar 160 and/or recess 162 may at least partially form and/or define the outlet of the module 10 and/or the filter housing 100 via which clean and/or filtered fluid is discharged from the module 10 and/or filter housing 100. When the filter element 200 is installed in the filter housing 100, the sealing elevation 268 of the tubular extension 266 of the second endplate 260 sealingly contacts, abuts, and/or presses against the inner circumferential surface of the annular collar 160 forming a fluid tight seal between the housing base 150 (e.g., the collar 160) and the filter element 200, support structure 204, second endplate 260, and/or tubular extension 266. In some examples, the collar 160 is configured to deform (e.g., elastically and/or plastically) the sealing elevation 268 to facilitate formation and/or enhancement of the fluid tight seal.

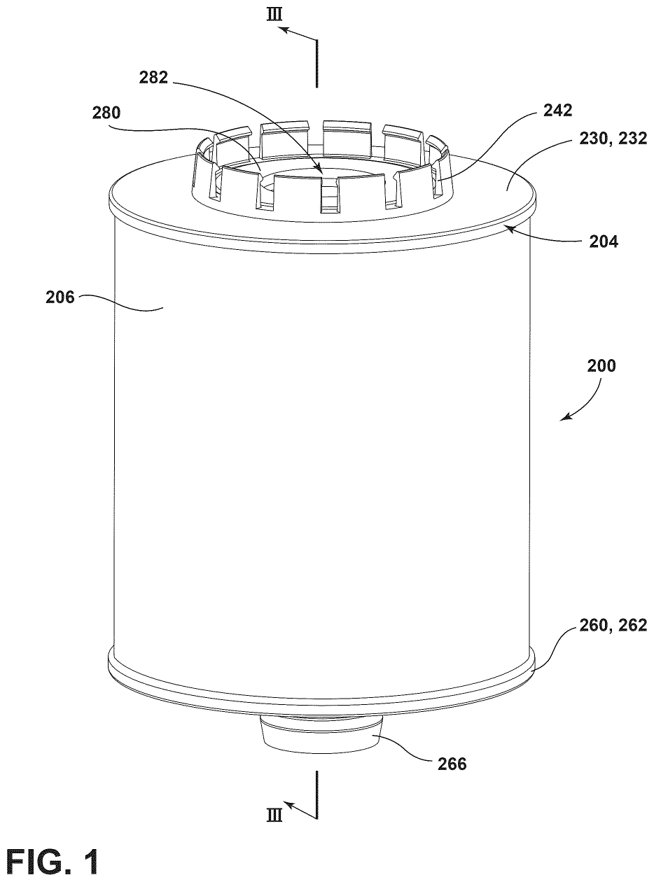

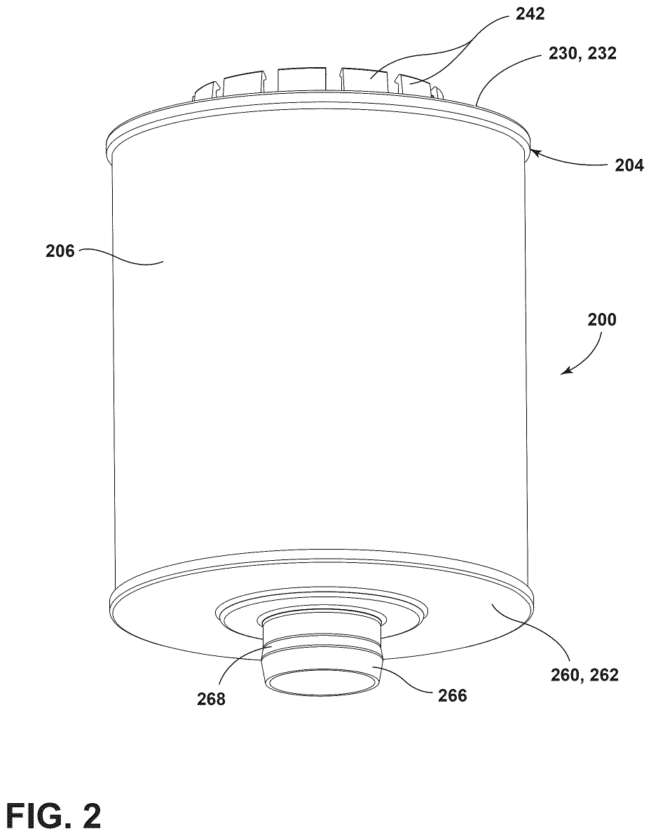

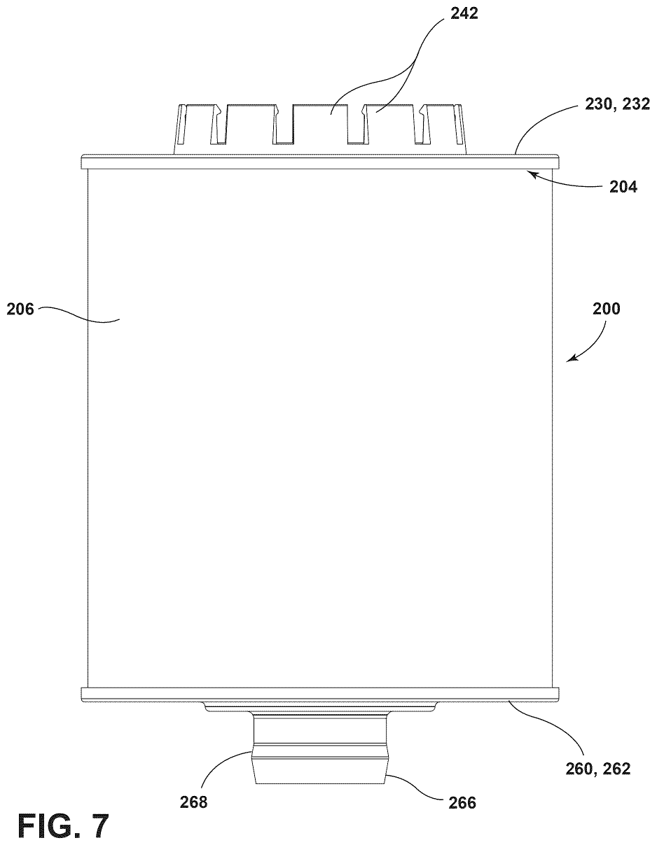

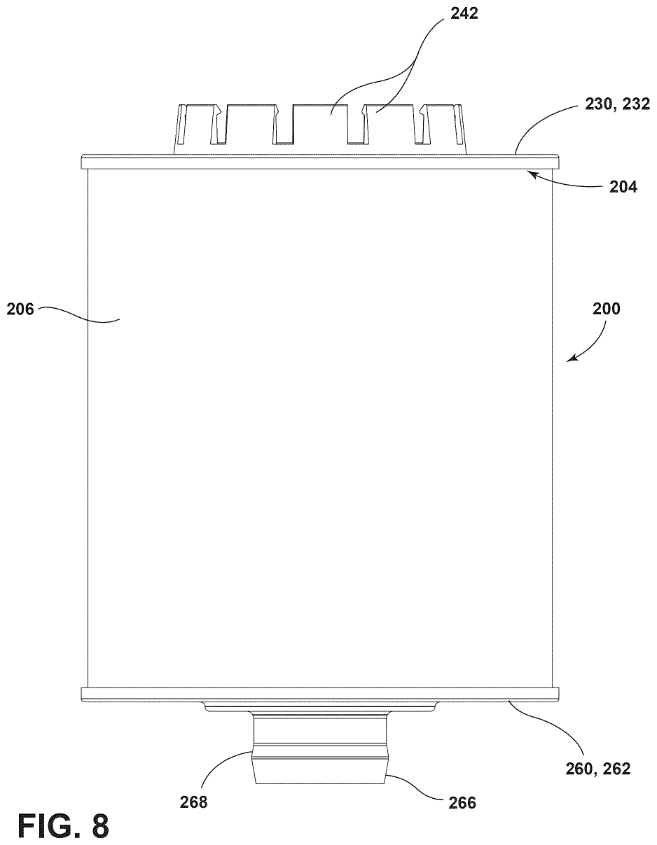

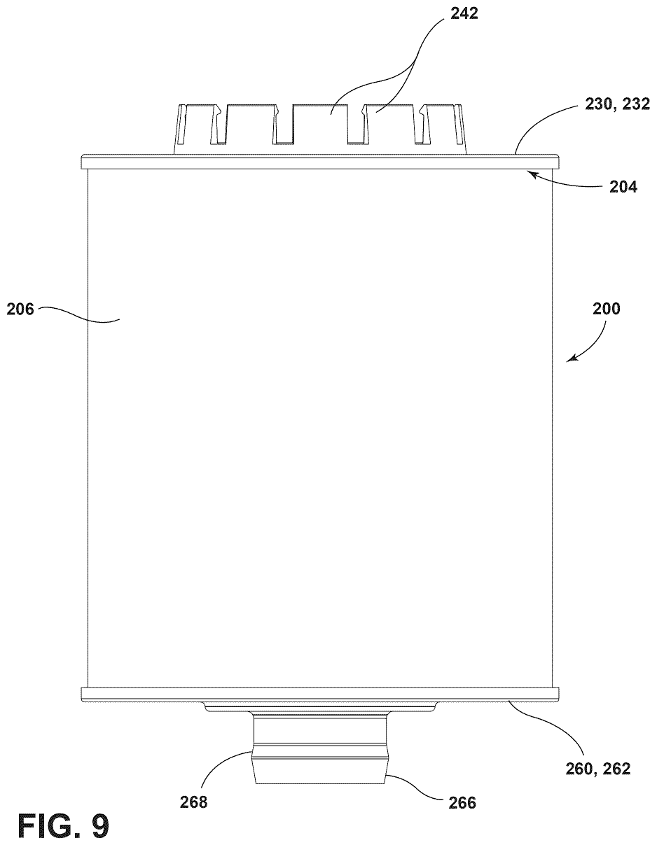

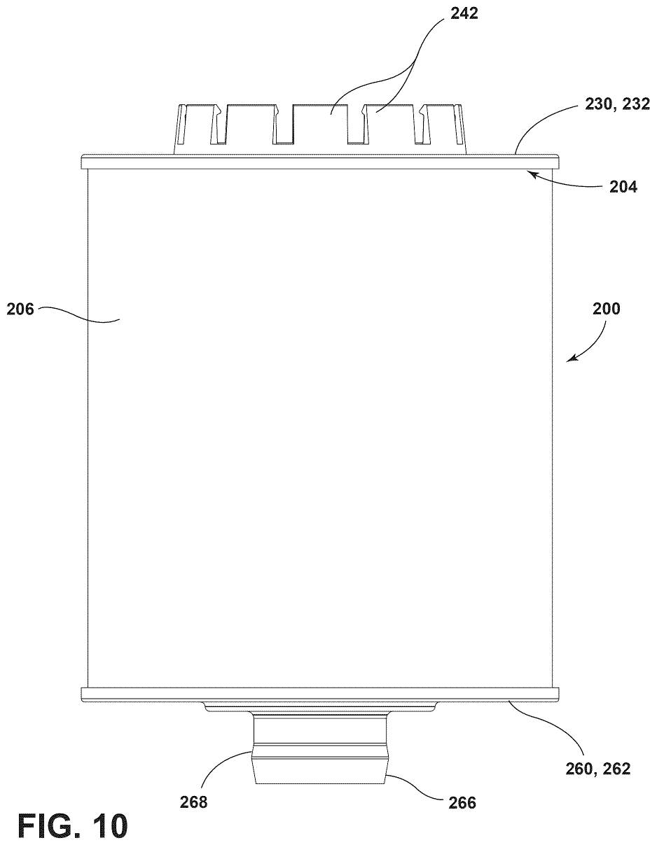

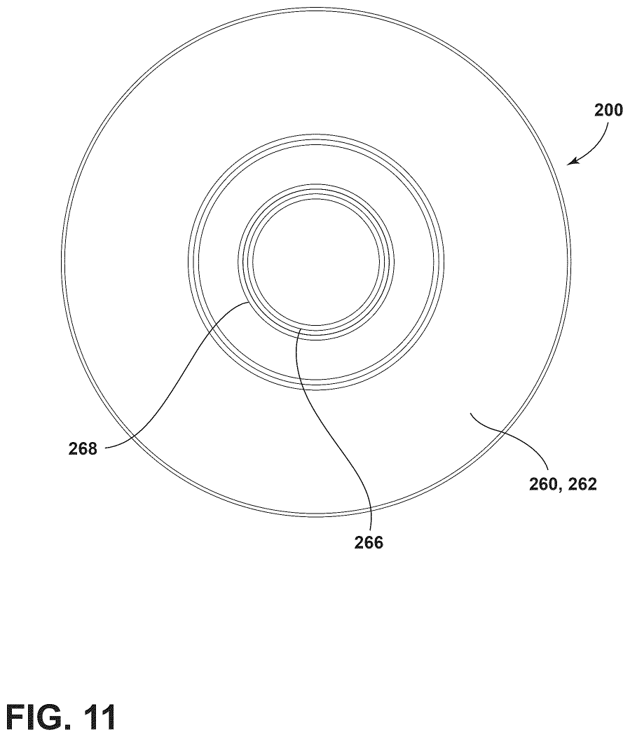

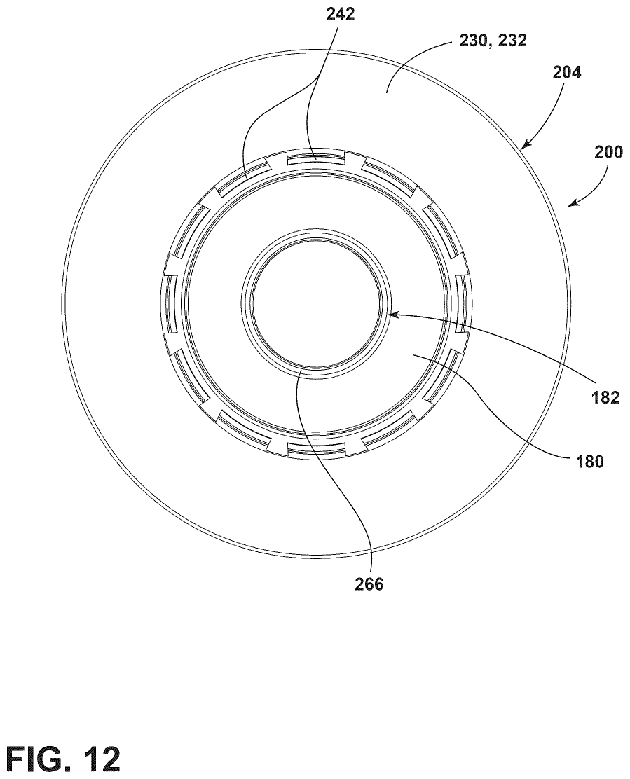

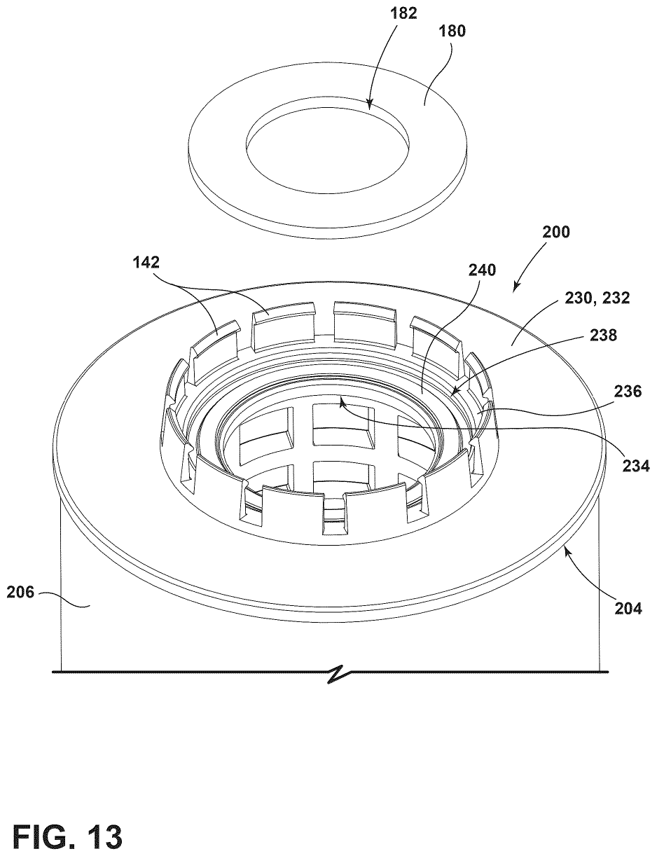

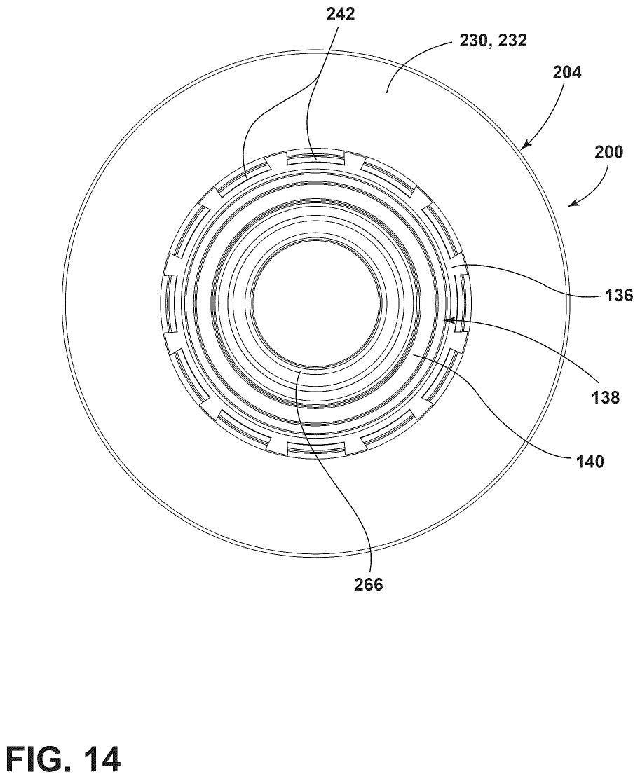

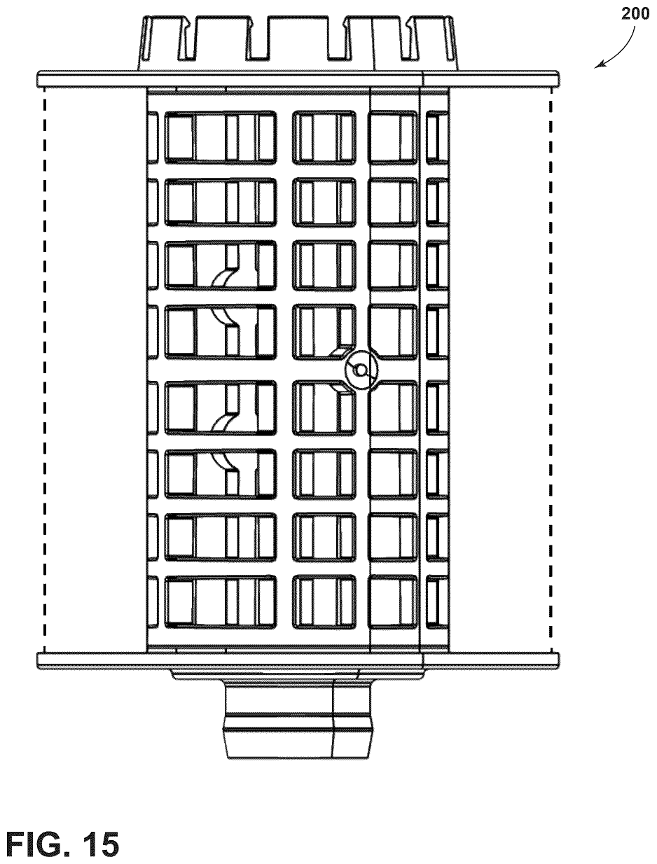

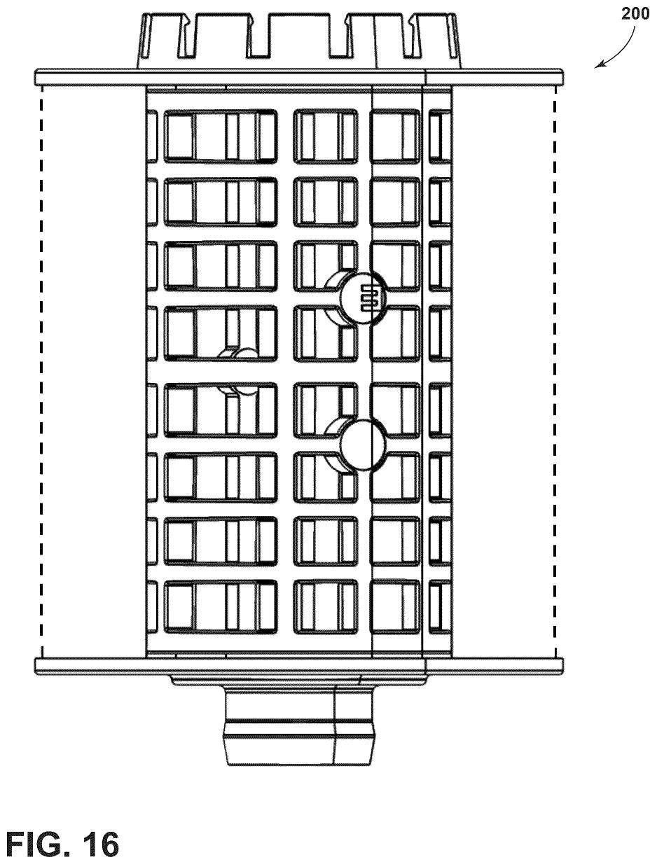

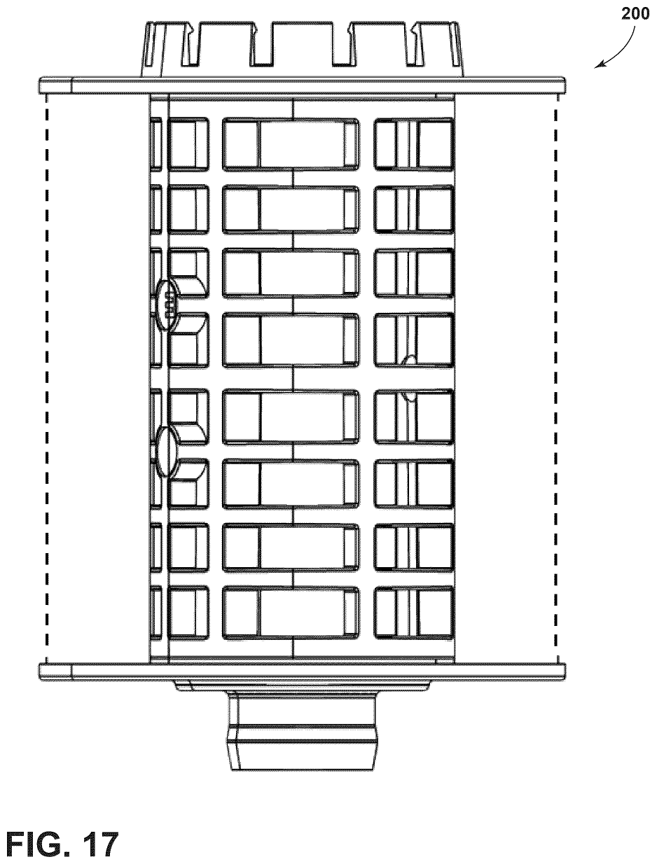

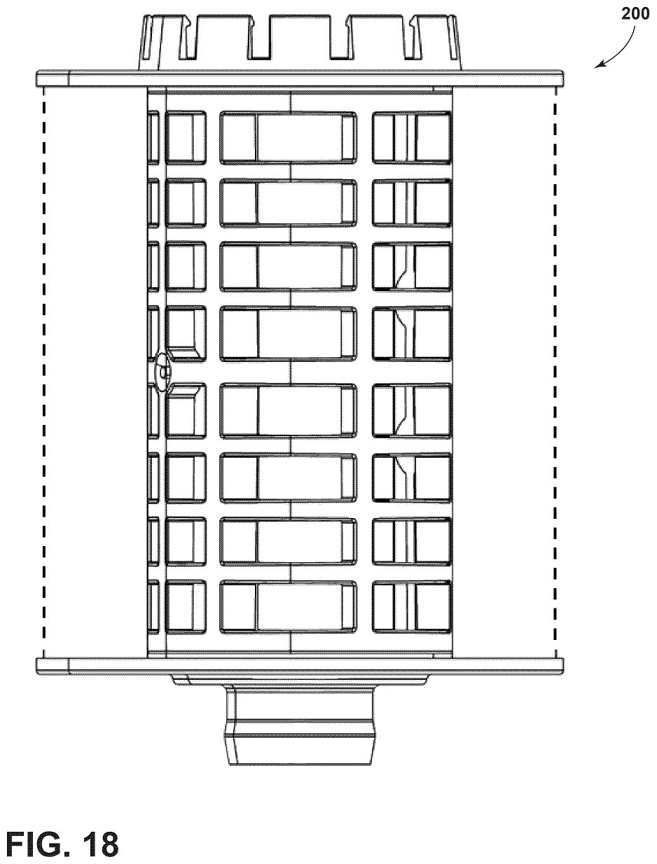

As generally shown in FIGS. 1-4B and 7-18, the filter element 200 is configured to filter a fluid (e.g., fuel, oil, lubricant), such as by collecting, removing, and/or filtering out particulate and/or contaminants from the fluid. The filter element 200 is at least partially arranged within and releasably connected to the filter housing 100, such as by the latches 242 and the tubular extension 266. The filter element 200 includes a central longitudinal axis 202, a support structure 204, a filter material 206 arranged on and supported by the support structure 204, and a fleece sealing disc 280. Various views of the filter element 200 are shown in FIGS. 7-12. A partially exploded view of the filter element 200 with the fleece sealing disc 280 disposed outside of the receptacle 238 is depicted in FIG. 13. A top-down view of the filter element 200 with the fleece sealing disc 280 removed/hidden is depicted in FIG. 14. Various views of the filter element 200 are shown in FIGS. 15-18 with a transparent depiction of the filter material 206 to provide an unobstructed view of the support structure 204 and/or the interior tube 210.

The filter material 206 is configured to remove and/or collect impurities from the raw and/or dirty fluid flowing through the module 10 (e.g., from the inlet and/or raw fluid space to the axial passageway 212, the clean fluid space, and/or outlet). The filter material 206 is a pleated filter media composed at least partially of paper in the illustrative example herein, though it will be appreciated that filter material 206 may have other shapes and/or configurations. The filter material 206 is arranged on and extends circumferentially around the interior tube 210 between the first endplate 230 and the second endplate 260. The filter material 206 is connected to the support structure 204, such as to the interior tube 210 and/or one or more of the endplates 230, 260 (e.g., via adhesive, welding, laser welding, one or more mechanical fasteners, etc.).

As generally illustrated in FIGS. 1-6B, the filter material 206 is arranged on and connected to the support structure 204. The support structure 204 provides stability to and/or supports the filter material 206. The support structure 204 is at least partially arranged within and releasably connected to the filter housing 100 (e.g., the cover 110 and/or the housing base 150 thereof). The support structure 204 includes a plurality of endplates (e.g., a first endplate 230 and a second endplate 260) and an interior tube 210. The support structure 204 and/or the elements, portions, and/or components thereof (e.g., the interior tube 210, the first endplate 230, and/or the second endplate 260) are typically composed of plastic, but other material compositions are conceivable.

In the illustrative example herein, the support structure 230, the first endplate 230, and the second endplate 260 are structured as separate, discrete elements and/or components that are assembled and/or connected to form the support structure 204. Alternatively, the support structure 230, the first endplate 230, the second endplate 260, and the elements, portions, and/or components thereof may be integrally formed such that the support structure 230 is a single, monolithic component.

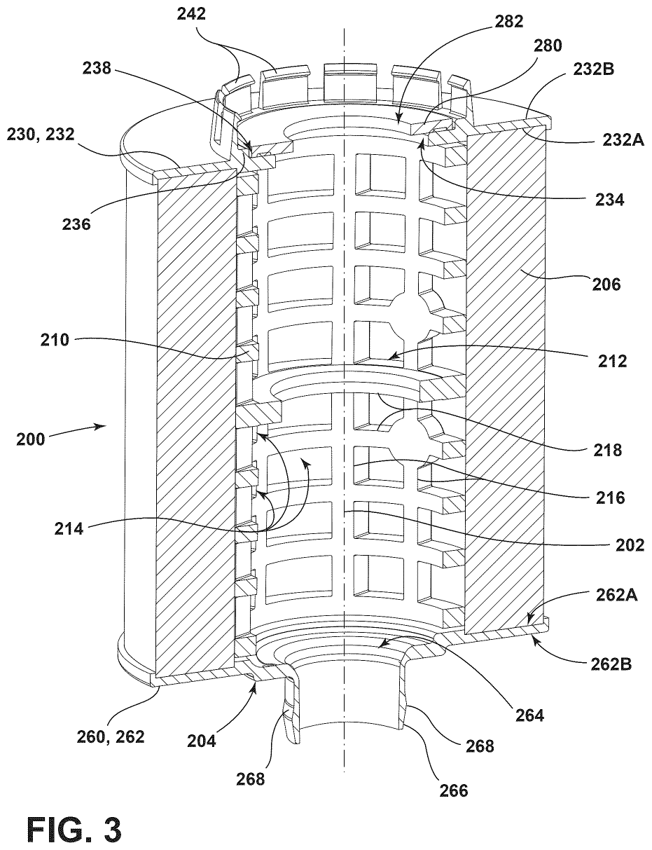

As generally shown in FIG. 3, the interior tube 210 is an elongated annular body defining an axial passageway 212. The cleaned and/or filtered fluid that has passed through the filter material 206 flows into the axial passageway 212, which may thus be considered and/or referred to as a clean fluid space of the module 10. A first end of the interior tube 210 is connected to the first endplate 230 and a second opposite end of the interior tube 210 is connected to the second endplate 260. As such, the interior tube 210 extends between and connects the endplates 230, 260. The axial passageway 212 extends between the endplates 230, 260 and fluidically connects the second endplate opening 264 with the apertures 214 and/or the filter material 216. The interior tube 210 includes a plurality of apertures 214 via which fluid is flowable through the interior tube 210 and/or the support structure 204 (e.g., in a radially inward direction and/or toward the axis 202) into the axial passageway 212. The apertures 214 extend radially through the interior tube 210 (e.g., from an inner circumferential surface to an outer circumferential surface). The filter material 206 extends around the interior tube 210 (e.g., in the circumferential direction) and is disposed on and/or connected to an outer (e.g., circumferential) surface of the interior tube 210, such as via adhesive and/or welding for example. The interior tube 210 radially supports the filter material 206 and/or substantially prevents the filter material 206 from encroaching into the axial passageway 212 and restricting fluid flow therethrough.

Optionally, the interior tube 210 is structured and/or configured as a lattice and/or grid body, structure, and/or framework that includes and/or is defined by a plurality of first members 216 and a plurality of second members 218. The first and second members 216, 218 are connected to one another to form and/or define a plurality of cells and/or grid-openings, which define the apertures 214 of the interior tube 210. The first members 216 (e.g., axial members) extend in the axial direction and are arranged and/or distributed around the axis 202 in the circumferential direction. The second members 218 extend transversely (e.g., perpendicularly or obliquely) relative to the first members 216 and connect the first members 216 to one another. In the illustrative example herein, the second members 218 are each annular and/or ring-shaped, extend in the circumferential direction, and are connected to each of the first members 216.

As generally shown in FIGS. 1 and 3-5B, the first endplate 230 is a generally planar and/or disc-shaped body 232 disposed at and connected to an end of the interior tube 210 opposite the second endplate 260. The first endplate 230 has a circular and/or annular shape, but may have another shape (e.g., elliptical, polygonal, triangular, rectangular) in other examples. The filter material 206 is disposed on and/or supported by an inner axial surface and/or face 232A of the first endplate 230 that faces the second endplate 260, the interior tube 210, and/or the filter material 206. The first endplate 230 includes a first endplate opening 234, an annular elevation 236, a receptacle 238 configured to receive and/or retain the fleece sealing disc 280, a plurality of latches 242, and/or, optionally, an attachment protrusion 240. In the illustrative example herein, the elements, portions, and/or components of the first endplate 230 (e.g., the body 232, the annular elevation 236, the attachment protrusion 240, and the latches 242) are integrally formed such that the first endplate 230 is a single, monolithic component. Alternatively, one or more portions, elements, and/or components of the first endplate 230 may be structured as separate, discrete elements and/or components that are assembled and/or connected to form the first endplate 230.

The first endplate opening 234 is configured to removably receive the standpipe 120 of the cover 110 of the filter housing 100. The first endplate opening 234 allows and/or enables the standpipe 120 to project through the first endplate 230 into the axial passageway 212 and/or the interior tube 210. The first endplate opening 234 is disposed in, defined by, and extends axially through first endplate 230 (e.g., from the inner axial surface 232A to an opposite outer axial surface 232B). The first endplate opening 234 is at least partially surrounded by the annular elevation 236 and/or the attachment protrusion 240 in the circumferential direction, and is disposed within the receptacle 238.

The internal diameter ID_{EO} of the first endplate opening 234 is larger than the internal diameter ID_{DO} of the disc opening 282 and the external diameter ED_{S} of the standpipe 120, which enables the standpipe 120 and the deformed portion to fleece sealing disc 280 to be simultaneously received in the first endplate opening 234 and, optionally, fit therein snuggly and/or in a fluid tight manner. In some examples, the difference in the internal diameter ID_{EO} of the first endplate opening 234 and the external diameter ED_{S} of the standpipe 120 is smaller than the original axial thickness T_{FSD} of the fleece sealing disc 280 (i.e., the thickness prior to deformation) such that the fleece sealing disc 280 is compressed in the radial direction between the first endplate 230 and the standpipe 120 and forms a fluid tight seal therebetween when the filter element 200 is installed in the filter housing 100 and/or cover 110. The internal diameter ID_{EO} of the first endplate opening 234 is smaller than an internal diameter ID_{IT} of the interior tube 210 (i.e., the external diameter of the axial passageway 212) in the illustrative example herein. Nevertheless, the internal diameter ID_{EO} of the first endplate opening 234 may alternatively be equal to and/or larger than an internal diameter ID_{IT} of the interior tube 210 (i.e., the external diameter of the axial passageway 212) in other examples.

In examples in which the internal diameter ID_{EO} of the first endplate opening 234 is smaller than the internal diameter ID_{IT} of the interior tube 210, such as the one depicted in FIGS. 3-5B, the deformed portion of the fleece sealing disc 280 extending in the axial direction is disposed radially between, compressed by, and in sealing contact with the standpipe 120 and the first endplate 230 (e.g., an inner circumferential surface thereof that defines and/or delimits the first endplate opening 234) forming a fluid tight seal therebetween (see, e.g., FIG. 5B). In other examples in which the internal diameter ID_{EO} of the first endplate opening 234 is equal to the internal diameter ID_{IT} of the interior tube 210, the deformed portion of the fleece sealing disc 280 is i) disposed radially between, compressed by, and in sealing contact with the standpipe 120 and the first endplate 230 (e.g., an inner circumferential surface thereof that defines and/or delimits the first endplate opening 234) forming a fluid tight seal therebetween and ii) disposed radially between, compressed by, and in sealing contact with the standpipe 120 and the interior tube 210 (e.g., an inner circumferential surface thereof that defines and/or delimits the axial passageway 212) forming a fluid tight seal therebetween. In further examples in which the internal diameter ID_{EO} of the first endplate opening 234 is larger than the internal diameter ID_{IT} of the interior tube 210, an axial end of the first endplate opening 234 is partially covered and/or closed by the interior tube 210 such that the first endplate opening 234 is structured as and/or similar to a counterbore disposed at an end of the axial passageway 212. In such configurations the deformed portion of the fleece sealing disc 280 is i) disposed radially between, compressed by, and in sealing contact with the standpipe 120 and the first endplate 230 (e.g., an inner circumferential surface thereof that defines and/or delimits the first endplate opening 234) forming a fluid tight seal therebetween and/or is ii) disposed axially on, pressed against (e.g., by way of the standpipe 120), and/or in sealing contact with an axial surface of the interior tube 210, which forms a fluid tight seal therebetween.

The annular elevation 236 is a generally ring-shaped protrusion that, in conjunction with the first endplate 230, forms and/or defines the receptacle 238 for receiving and/or retaining the fleece sealing disc 280. The annular elevation 236 projects axially from the outer axial surface and/or face 232B of the first endplate 230 that faces away from the interior tube 210 and/or the second endplate 260. The annular elevation 236 has a generally rectangular radial cross-section, but other shapes are conceivable. The receptacle 238 is defined and/or delimited by the annular elevation 236 (e.g., an inner circumferential surface thereof) and the outer axial surface 232B of the first endplate 230, with the annular elevation 236 defining an outer circumferential boundary of the receptacle 238. The annular elevation 236 extends around the first endplate opening 234 and the fleece sealing disc 280 in the circumferential direction. The annular elevation 236 is offset and/or disposed spaced apart from an outer perimeter of the first endplate opening 234 in a radially outward direction. In other words, the first endplate opening 234 is disposed within the receptacle 238 and/or in the portion of the first endplate 230 that defines and/or delimits the receptacle 238. Optionally, an axial height and/or dimension of the annular elevation 236 substantially corresponds to the axial thickness T_{FSD} of the fleece sealing disc 280. The annular elevation 236 helps protect and/or shield the fleece sealing disc 280 from inadvertent contact by a user and/or other structures (e.g., when handling the filter element 200 and/or during installation), which could disconnect the fleece sealing disc 280 from the first endplate 230 and/or damage the fleece sealing disc 280. The receptacle 238 and the annular elevation 236 also facilitate proper positioning of the fleece sealing disc 280 on the first endplate 230 during manufacturing, which helps ensure that the fleece sealing disc 280 and/or the disc opening 282 are properly positioned and/or aligned with the first endplate opening 234 so that the fleece sealing disc 280 engages and is deformed by the standpipe 120 of the cover 110 during installation of the filter element 200 in the filter housing 100 and/or cover 110.

The first endplate 230 further includes a plurality of latches 242 via which the support structure 204 and/or the filter element 200 is connectable and/or connected to the cover 110. The latches 242 of the first endplate 230 are configured to releasably engage the mating formations 124 of the cover 110. The latches 242 of the first endplate 230 are configured to releasably engage the mating formations 124 of the cover 110. The latches 242 each contact and/or engage a respective mating formation 124 of the cover 110 to connect, attach, couple, fasten, and/or secure the filter element 200 and/or the support structure 204 to the cover 110 and/or the filter housing 100. Optionally, the latches 242 are configured to elastically deform and/or to be deflected radially outward (e.g., away from the central longitudinal axis 202) to a deflected position, such as via the sloped surface 132 of the respective mating formation 124, when inserting the filter element 200 into the cover 110. The latches 242 are also optionally configured to return to an undeflected position when a portion of the mating formation 124 (e.g., the tab 128 and/or the stop surface 130 thereof) passes a portion of the latch 242 (e.g., the tab 246 and/or the stop surface 248 thereof) such that the mating formation 124 transitions (e.g., from contacting a sloped surface 250 of the latch 242) to contacting the stop surface 248 of the latch 242.

The latches 242 are disposed on and project transversely (e.g., obliquely or perpendicularly) from the outer axial surface 232B of the first endplate 230 and/or an axial surface of the annular elevation 236 toward the bottom 116 of the cover 110 and/or away from the filter material 206 (e.g., generally in the axial direction). The latches 242 are arranged circumferentially around the first endplate opening 234 and/or the receptacle 238.

The latches 242 each include an elongated projection 244 and a tab 246. The projection 244 is disposed on and projects transversely (e.g., obliquely or perpendicularly) from the first endplate 230 and/or the annular elevation 236 toward the bottom 116 of the cover 110 and/or away from the filter material 206 (e.g., generally in the axial direction). The tab 246 projects radially inward from the projection 244, such as at, about, and/or adjacent to a free end of the projection 244. The tab 246 includes a stop surface 248 that faces generally toward first endplate 230 and/or the filter material 206. Optionally, the tab 246 also includes a sloped and/or inclined surface 250 that may, for example, facilitate elastic deformation and/or deflection of the latch 242 and/or the mating formation 124.

Optionally, the first endplate 230 further includes an attachment protrusion 240 configured to facilitate attachment of the fleece sealing disc 280 to the first endplate 230. The attachment protrusion 240 is a generally ring-shaped (e.g., annular) protrusion that projects axially from the outer axial surface 232B of the first endplate 230. The attachment protrusion 240 is disposed within the receptacle 238 radially between the first endplate opening 234 and the annular elevation 236, and extends around the first endplate opening 234 in the circumferential direction. The attachment protrusion 240 is at least partially integrated in the fleece sealing disc 280 (e.g., via laser welding) to secure, connect, and/or attach the fleece sealing disc 280 and the first endplate 230. The attachment protrusion 240 may, for example, be at least partially melted (e.g., via laser welding) such that the material of the attachment protrusion 240 flows into interior spaces and/or gaps in the material of the fleece sealing disc 280 and then allowed to harden therein to establish a secure connection of the fleece sealing disc 280 to the first endplate 230. The fleece sealing disc 280 may additionally and/or alternatively be connected to the first endplate 230 in one or more other manners (e.g., via adhesive and/or one or more mechanical fasteners). In some examples utilizing another type of connection (e.g., an adhesive connection) to connect the first endplate 230 and the fleece sealing disc 280, the first endplate 230 does not include an attachment protrusion 240.

As generally shown in FIGS. 1-3, 6A, and 6B, the second endplate 260 is a generally planar and/or disc-shaped body 262 disposed at and connected to an end of the interior tube 210 opposite the first endplate 230. The second endplate 260 and/or body 262 has a circular and/or annular shape, but may have another shape (e.g., elliptical, polygonal, triangular, rectangular) in other examples. The filter material 206 is disposed on and/or supported by an inner axial surface and/or face 262A of the second endplate 260 that faces the first endplate 230, the interior tube 210, and/or the filter material 206. In the illustrative example herein, the elements, portions, and/or components of the second endplate 260 (e.g., the body 262, the tubular extension 266, the sealing elevation 268) are integrally formed such that the second endplate 260 is a single, monolithic component. Alternatively, one or more portions, elements, and/or components of the second endplate 260 may be structured as separate, discrete elements and/or components that are assembled and/or connected to form the second endplate 260.

The second endplate 260 includes a second endplate opening 264 and a tubular extension 266. The second endplate opening 264 is configured to allow clean fluid in the axial passageway 212 to flow through the second endplate 260 to the collar 160 and/or recess 162 of the housing base 150 for discharge from the module 10. The second endplate opening 264 is disposed in, defined by, and extends axially through second endplate 260 (e.g., from the inner axial surface 262A to an opposite outer axial surface 262B). The second endplate opening 264 is at least partially surrounded by the tubular extension 266, which is insertable into and/or removably arranged in the collar 160 of the housing base 150.

The tubular extension 266 is configured to be received in and sealingly engage the annular collar 160 of the housing base 150. The tubular extension 266 is an annular projection that extends and/or protrudes transversely (e.g., perpendicularly and/or obliquely) from the second endplate 260 (e.g., the outer axial surface 262B) away from the filter material 206 and/or the interior tube 210 (e.g., generally in the axial direction). The tubular extension 266 also extends circumferentially around an outer perimeter of the second endplate opening 264 (e.g., generally in the circumferential direction). The second endplate 260 and/or the tubular extension 266 includes a sealing elevation, protrusion, and/or bead 268 that extends circumferentially around the tubular extension 266. The sealing elevation 268 is disposed on and projects radially outward from an outer circumferential surface of the tubular extension 266. The sealing elevation 268 is configured to contact, abut, and/or press against the housing base 150 (e.g., the inner circumferential surface of the collar 160) forming a fluid tight seal therebetween. Optionally, the sealing elevation 268 may (e.g., elastically) deform when inserting the tubular extension 266 into the collar 160, which may facilitate formation of and/or enhance the fluid tight seal. The sealing elevation 268 is an integral portion of the tubular extension 266 and, thus, composed of the same (e.g., plastic) material as the tubular extension 266 and the second endplate 260.

Due to the tubular extension 266 and the sealing elevation 268, a fluid tight seal can be established between the second endplate 260 and the housing base 150 without the use of any sealing ring (e.g., one or more O-rings). In other words, the tubular extension 266 and the sealing elevation 268 effectively eliminate the need for one or more sealing rings to be arranged between the second endplate 260 and the housing base 150, which sealing ring(s) can become damaged, are susceptible to jamming, and/or can cause the filter element 200 to become bound up during installation. The tubular extension 266 and the sealing elevation 268 further enable the second endplate 260 to be free of (i.e., to not include any) insertion and/or positioning guides, such as insertion and/or positioning guides that are provided in some existing filter modules to help avoid the challenges created by the aforementioned sealing rings that are notably absent from the filter module 10 disclosed herein. As a result, the fluid filter module 10 and/or the filter element 200 has fewer components, elements, and/or parts and, thus, is cheaper and/or less costly to manufacture. The filter element 200 may also be less susceptible to becoming bound up, jammed, damaged, and/or broken during installation in the filter housing 100 due to the absence of insertion and/or positioning guides and the sealing ring. The absence of insertion and/or positioning guides and sealing rings that are common in some existing fluid modules also facilitates and/or simplifies the installation process since the filter element 200 is capable of being installed in the filter housing 100 at a wider variety of positions and/or orientations. For example, unlike some existing filter module designs, the user is not required to position and/or orient the filter element 200 relative to the housing base 150 to align insertion and/or positioning guides with associated features of the housing base 150 prior to and/or during insertion and/or installation of the filter element 200.

The fleece sealing disc 280 is configured to sealingly engage and/or contact the support structure 204 and the cover 110 (e.g., the standpipe 120) to form and/or provide a fluid tight seal therebetween. The fleece sealing disc 280 is at least partially composed of a fleece material that may absorb and/or retain a small amount of raw fluid, which substantially restricts and/or prevents the raw fluid from flowing through the fleece sealing disc 280.

The fleece sealing disc 280 is deformable (e.g., elastically) and configured to deform (e.g., via interacting with and/or being contacted by the standpipe 120 of the cover 110) during installation of the filter element 200 in the filter housing 100 and/or when connecting the support structure 204 and the cover 110 together. The fleece sealing disc 280 is a generally planar body (e.g., prior to deformation during installation of the filter element 200 in the filter housing 100 and/or prior to connecting the support structure 204 and the cover 110 together) having a circular and/or annular shape, but may have another shape (e.g., elliptical, polygonal, triangular, rectangular) in other examples.

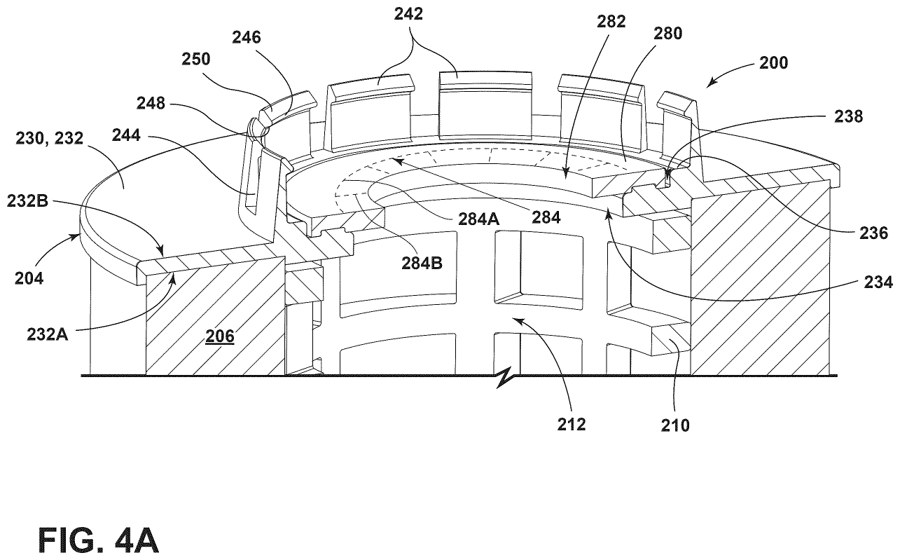

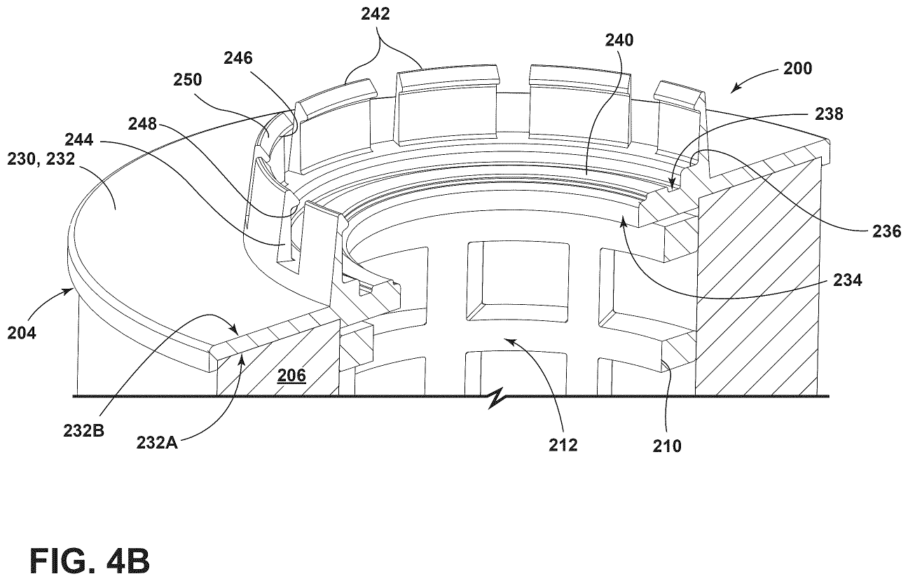

The fleece sealing disc 280 is disposed in the receptacle 238, and rests on and/or is secured to (e.g., fixed) to the first endplate 230, such as by the attachment protrusion 240. The fleece sealing disc 280 is oriented transversely (e.g., obliquely or perpendicularly) to the axis 202 and/or the axial direction and is arranged at least partially aligned with the first endplate opening 234 in the axial direction. At least prior to installation of the filter element 200 in the filter housing 100 and/or prior to connecting the support structure 204 and the cover 110 together (see, e.g., FIGS. 4A and 5A), a portion of the fleece sealing disc 280 is disposed over and at least partially covers the first endplate opening 234. As generally illustrated in FIG. 5B, during installation of the filter element 200 in the filter housing 100 and/or when connecting the support structure 204 and the cover 110 together, at least a portion of the fleece sealing disc 280 is deformed via the standpipe 120 of the cover 110 such that a portion of the fleece sealing disc 280 (e.g., the portion of the fleece sealing disc 280 that initially partially covered the first endplate opening 234), which may be referred to as the deformed portion, extends axially and projects axially into the first endplate opening 234 and/or the axially passageway 212. The deformed portion of the fleece sealing disc 280 is also disposed radially between, compressed by, and in sealing contact with the support structure 204 (e.g., the first endplate 230 and/or the interior tube 210) and the filter housing 100 (e.g., the standpipe 120 of the cover 110) forming a fluid tight seal therebetween. The remainder and/or undeformed portion of the fleece sealing disc 280 still extends transversely (e.g. obliquely or perpendicularly) to the deformed portion of the fleece sealing disc 280, the standpipe 120, and/or the axis 202, remains arranged in the receptacle 238 and on the outer axial surface 232B of the first endplate 230, and is connected to the first endplate 230 by the attachment protrusion 240.

The fleece sealing disc 280 includes a disc opening 282 that is disposed in and defined by the fleece sealing disc 280. The disc opening 282 is configured to removably receive the standpipe 120 of the cover 110 of the filter housing 100. The disc opening 282 allows and/or enables the standpipe 120 to project through the fleece sealing disc 280 and into the first endplate opening 234, the first endplate 230, the axial passageway 212, and/or the interior tube 210. The disc opening 282 extends axially through the fleece sealing disc 280 (e.g., from the inner axial surface to an opposite outer axial surface). The fleece sealing disc 280 is configured to deform such that an internal diameter ID_{DO} of the disc opening 282 is increased (e.g., from an initial/first dimension to a larger second/widened dimension) and the disc opening 282 widened when deformed. The internal diameter ID_{DO} of the disc opening 282 initially has a first dimension (i.e., prior to deformation of the fleece sealing disc 280) that is smaller than the external diameter ED_{S} of the standpipe 120, the internal diameter ID_{EO} of the first endplate opening 234, and the internal diameter ID_{IT} of the interior tube 210 as generally illustrated in FIG. 5A. When the fleece sealing disc 280 is deformed by the standpipe 120, the internal diameter ID_{DO} of the disc opening 282 has a second dimension that is larger than the first/initial dimension and substantially equal to the external diameter ED_{S} of the standpipe 120 as generally illustrated in FIG. 5B. This ensures that the fleece sealing disc 280 engages the standpipe 120 tightly and is deformed by the standpipe 120 when the standpipe 120 is inserted into and/or through the disc opening 282.

The standpipe 120, the collar 160, the recess 162, the interior tube 210, the axial passageway 212, the first endplate 230, the first endplate opening 234, the annular elevation 236, the receptacle 238, the attachment protrusion 240, the second endplate 260, the second endplate opening 264, the tubular extension 266, the fleece sealing disc 280, and/or the disc opening 282 are at least partially aligned with one another in the axial direction and/or are arranged coaxially along the axis 202. This arrangement, however, is not required.

Optionally, the fleece sealing disc 280 further includes a weakness formation 284 that is structured and arranged to facilitate and/or guide deformation of the fleece sealing disc 280. The weakness formation 284 also facilitates and/or makes it easier to deform (e.g., bend and/or stretch) the fleece sealing disc 280, which reduces the amount of force a user must exert to deform the fleece sealing disc 280 during installation. This, in turn, makes installation easier and enhances user experience.

The weakness formation 284 may include and/or be structured as one or more weakened regions and/or one or more lines of weakness (e.g., lines of weakness 284A, 284B). A weakened region and/or a line of weakness may, for example, be formed as and/or defined by one or more perforations (e.g., small and/or micro-sized holes), creases, indentations, scores, faults, and/or other deformations that locally weakens the fleece sealing disc 280 (e.g., by forming a weak point or region in the material structure of the fleece sealing disc 280). Forces exerted on the fleece sealing disc 280 tend to concentrate in, at, and/or along the weakness formation 284 during installation resulting in deformation (e.g., bending and/or stretching) of the fleece sealing disc 280 occurring (e.g., first and/or primarily) in, at, and/or along the weakness formation 284. The weakness formation 284 is positioned adjacent and/or in close proximity to the disc opening 282 and the weakened region(s) and/or line(s) of weakness thereof are arranged in one or more patterns or designs that guide deformation of the fleece sealing disc 280 in the desired manner. In this way, the weakening formation 284 is structured and arranged to facilitate and guide deformation of the fleece sealing disc 280 caused by the standpipe 120 when installing the filter element 200 in the cover 110 and/or filter housing 100.

In the illustrative example herein, the weakness formation 284 includes a round and/or circular line of weakness 284A (e.g., perforation, crease, score, etc.) along which the fleece sealing disc 280 is deformed (e.g., bent) when deformed by the standpipe 120. In other words, the fleece sealing disc 280 is configured to deform (e.g., bend) along the round line of weakness 284A when inserting the standpipe 120 into the disc opening 282. The round line of weakness 284A extends circumferentially around the disc opening 282 and is substantially aligned with (e.g., disposed directly above and/or slightly radial offset from) the outer perimeter of the first endplate opening 234 in the axial direction. The round line of weakness 284A, in particular, guides and/or leads the fleece sealing disc 280 to deform (e.g., bend) around an interior edge of the first endplate 230 that forms and/or defines the first endplate opening 234 during installation so that the deformed portion of the fleece sealing disc 280 projects axially into the first endplate opening 234 and/or the axially passageway 212.

Optionally, the weakness formation 284 may also include a plurality of radially extending lines of weakness 284B (e.g., perforations, creases, scores) disposed circumferentially around the first endplate opening 234 and emanating from the first endplate opening 234. In the illustrative example herein, the radial lines of weakness 284B intersect one another at the axis 202 forming a starburst shape. In another example, the radial lines of weakness 284B are arranged in pairs that are angled toward one another and/or intersect at the edge of the first endplate opening 234 and/or at the round line of weakness 284A. The radial lines of weakness 284B facilitate stretching of the fleece sealing disc 280 and/or widening of disc opening 282 to accommodate the standpipe 120 during installation. In other words, the fleece sealing disc 280 is configured to deform (e.g., stretch) along the radial lines of weakness 284B to widen the first endplate opening 234 when inserting the standpipe 120 into the disc opening 282. The radial lines of weakness 284B may also reduce the likelihood of the fleece sealing disc 280 tearing, ripping, and/or otherwise being damaged during deformation (e.g., stretching) of the fleece sealing disc 280 and/or widening of the disc opening 282.

An exemplary method and/or process of assembling a fluid filter module 10 and/or of installing a filter element 200 in a filter housing 100 is generally illustrated in FIGS. 5A-6B. The method includes connecting the filter element 200 and the cover 110 of the filter housing 100 together as shown in FIGS. 5A and 5B and connecting the filter element 200 and the housing base 150 of the filter housing 100 together as shown in FIGS. 6A and 6B. The method generally involves connecting the filter element 200 and the cover 110 to form a subassembly and, subsequently, connecting the subassembly and the housing base 150 together. Conceivably, the method may alternatively include connecting the filter element 200 and the housing base 150 together to form a subassembly and, subsequently, connecting the subassembly and the cover 110 together.

As generally illustrated in FIGS. 5A and 5B, connecting the filter element 200 and the cover 110 together includes providing a filter element 200 and a cover 110. Next, the filter element 200 is at least partially positioned within the cover 110 via inserting at least a portion of the filter element 200 into the cavity 114 of the cover 110 through the open end of the cover 110. Inserting the filter element 200 into the cavity 114 of the cover 110 includes inserting the first endplate 230, a portion of the interior tube 210, and a portion of the filter material 206 into the cavity 114 of the cover 110 to dispose, position, and/or arrange the first endplate 230, a portion of the interior tube 210, and a portion of the filter material 206 in the cover 110 and/or the cavity 114. The filter element 200 may be inserted into the cover 110 via moving and/or adjusting the cover 110 and/or the filter element 200 in the axial direction, such as toward the other one of the cover 110 and the filter element 200.

Inserting the filter element 200 into the cover 110 further includes inserting a portion of the standpipe 120 into the axial passageway 212 (e.g., in the axial direction). When inserting the filter element 200 into the cover 110, the standpipe 120 of the cover 110 is inserted partially into the axial passageway 212 via passing a portion of the standpipe 120 through the disc opening 282 and the first endplate opening 234 in the axial direction. Due its external diameter ED_{S} being larger than the internal diameter ID_{DO} of the disc opening 282, the standpipe 120 deforms the fleece sealing disc 280 (e.g., at and/or along the weakening formation 284) and moves at least a portion (e.g., a deformed portion) of the fleece sealing disc 280. Deforming the fleece sealing disc 280 may include deforming (e.g., bending) the fleece sealing disc 280 along the round line of weakness 284A and around an interior edge of the first endplate 230 that forms and/or defines the first endplate opening 234. Additionally and/or alternatively, deforming the fleece sealing disc 280 may include deforming (e.g., stretching) the fleece sealing disc 280 along the radial lines of weakness 284B and widening the disc opening 282 (e.g., increasing the internal diameter ID_{DO} of the disc opening 282 from a first/initial dimension that is smaller than the external diameter ED_{S} of the standpipe 120 to a second/widened dimension that is substantially equal to the external diameter ED_{S} of the standpipe 120). The deformed portion of the fleece sealing disc 280 is moved and/or adjusted axially into the first endplate opening 234 of the first endplate 230, an interior of the interior tube 210, and/or the axial passageway 212 as the standpipe 120 passes through the disc opening 282 and/or the first endplate opening 234 (e.g., via pushing, pulling, dragging, etc. the deformed portion of the fleece sealing disc 280 with it, such as due to a frictional force between the exterior surface of the standpipe 120 and one or more surfaces of the fleece sealing disc 280). The deformed portion of the fleece sealing disc 280 is also moved radially between and into radial sealing contact and/or abutment with one or more portions of the support structure 204, such as the first endplate 230 and/or the interior tube 210, and the standpipe 120 (e.g., an exterior circumferential surface thereof). As a result, the fleece sealing disc 280 is sandwiched and compressed (at least to an extent) between the standpipe 120 and the one or more portions of the support structure 204 (e.g., the first endplate 230 and/or the interior tube 210) as generally illustrated in FIG. 5B, which provides, establishes, and/or forms a fluid tight seal between the standpipe 120 and the support structure 204.

Inserting the filter element 200 into the cover 110 further includes engaging one or more latches 242 of the filter element 200 and one or more mating formations 124 of the cover 110 to connect, attach, couple, and/or secure the filter element 200 and the cover 110 to one another and, thus, form a subassembly. Engaging one or more latches 242 and one or more mating formations 124 may include engaging a (e.g., each) latch 242 of the filter element 200 with a respective mating formation 124. Engaging a latch 242 with a mating formation 124 may include bringing the latch 242 (e.g., the sloped surface 250) and the mating formation 124 (e.g., the sloped surface 132) into contact with one another, sliding the latch 242 and the mating formation 124 on and/or against one another, and engaging/contacting the stop surface 248 of the latch 242 and the stop surface 130 of the mating formation 124. The latch 242 and the mating formation 124 are brought into contact and slid against one another due to and/or via the movement of the filter element 200 and/or the cover 110 when inserting the filter element 200 into the cover 110. Sliding the latch 242 and the mating formation 124 on and/or against one another causes i) the latch 242 (e.g., the projection 244 thereof) to elastically deform and/or deflect radially outward and/or ii) the mating formation 124 (e.g., the projection 126 thereof) to elastically deform and/or deflect radially inward, thereby enabling the tabs 128, 246 of the latch 242 and the mating formation 124 to pass by one another so that the stop surfaces 130, 248 of the latch 242 and the mating formation 124 are capable of engaging and/or contacting one another. Due to the engagement of the stop surfaces 130, 248, which is generally illustrated in FIG. 5B, the filter element 200 and the cover 110 are connected to one another forming the subassembly, relative movement between the filter element 200 and the cover 110 (e.g., in the axial direction) is restricted and/or prevented, and/or removal of the filter element 200 from the cavity 114 of the cover 110 in the axial direction is restricted and/or prevented.

As generally illustrated in FIGS. 6A and 6B, connecting the subassembly and/or the filter element 200 thereof and the housing base 150 together includes positioning at least a portion of the filter element 200 within the housing base 150 via inserting at least a portion of the filter element 200 into the cavity 154 of the housing base 150 through the open end of the housing base 150. Inserting the filter element 200 into the cavity 154 of the housing base 150 includes inserting the second endplate 260, a portion of the interior tube 210, and a portion of the filter material 206 into the cavity 154 of the housing base 150 to dispose, position, and/or arrange the second endplate 260, a portion of the interior tube 210, and a portion of the filter material 206 in the housing base 150 and/or the cavity 154. The filter element 200 may be inserted into the housing base 150 via moving and/or adjusting the housing base 150 and/or the filter element 200 in the axial direction, such as toward the other one of the housing base 150 and the filter element 200.

Inserting the filter element 200 into the housing base 150 further includes inserting a portion of the tubular extension 266 of the second endplate 260 into the recess 162 and/or the collar 160 of the housing base 150 (e.g., in the axial direction), such as to sealingly engage, contact, and/or abut the sealing elevation 268 against the inner circumferential surface of the annular collar 160. This in turn provides, establishes, and/or forms a fluid tight seal between the housing base 150 and the filter element 200 (e.g., between the tubular extension 266 and the annular collar 160) and, to at least an extent, connects, attaches, secures, and/or holds the subassembly (e.g., the filter element 200 thereof) and the housing base 150 to one another. In some examples, inserting the tubular extension 266 into the collar 160 may include compressing and/or deforming the sealing elevation 268 with the annular collar 160 to facilitate formation of and/or enhance the fluid tight seal.

Connecting the subassembly and/or the filter element 200 thereof and the housing base 150 together further includes (e.g., directly) connecting the cover 110 and the housing base 150 together to form the filter housing 100. The cover 110 and the housing base 150 are generally connected to one another after inserting the tubular extension 266 into the collar 160 (e.g., while the cover 110 and the housing base 150 are held together by the abutment of the tubular extension 266 and the collar 160). Connecting the subassembly and/or the filter element 200 and the housing base 150 together includes screwing the cover 110 and the housing base 150 together by rotating the subassembly and the housing base 150 relative to one another to engage complimentary threads of the cover 110 and the housing base 150.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A filter element, comprising:
a support structure including:
a first endplate having a first endplate opening;
a second endplate having a second endplate opening; and
an axial passageway extending between the first endplate and the second endplate, the first endplate opening, the second endplate opening, and the axial passageway at least partially aligned with one another in an axial direction;
a filter material arranged on the support structure between the first endplate and the second endplate; and
a sealing disc arranged on the first endplate and at least partially covering the first endplate opening.

2. The filter element of claim 1, wherein the sealing disc is deformable and, during installation in a filter housing, is deformed by and sealing engages a portion of the filter housing.

3. The filter element of claim 2, wherein the sealing disc is configured to bend when deformed by the filter housing such that a deformed portion of the sealing disc projects axially into the first endplate opening and/or the axial passageway.

4. The filter element of claim 3, wherein:
the sealing disc includes a disc opening;
the first endplate opening and the disc opening are configured to receive a standpipe of the filter housing; and
the deformed portion of the sealing disc extends axially and is disposed radially between and in sealing contact with the first endplate and the standpipe.

5. The filter element of claim 4, wherein:
the sealing disc includes a line of weakness extending circumferentially around the disc opening and aligned with an outer perimeter of the first endplate opening in the axial direction; and
the sealing disc is configured to bend along the line of weakness when deformed by the filter housing.

6. The filter element of claim 2, wherein:
the sealing disc includes a disc opening configured to receive a standpipe of the filter housing;
an internal diameter of the disc opening initially has a first dimension; and
the internal diameter of the disc opening has a second dimension, which is larger than the first dimension, when the sealing disc is deformed by the filter housing.

7. The filter element of claim 6, wherein:
the sealing disc includes a plurality of lines of weakness disposed circumferentially around and emanating from the first endplate opening; and
the sealing disc is configured to stretch along plurality of lines of weakness to widen the disc opening when deformed by the filter housing.

8. The filter element of claim 1, wherein the sealing disc includes a disc opening arranged at least partially aligned with the first endplate opening in the axial direction.

9. The filter element of claim 7, wherein the disc opening has an internal diameter that is smaller than an internal diameter of the first endplate opening.

10. The filter element of claim 1, wherein the sealing disc is a fleece sealing disc.

11. The filter element of claim 1, wherein the first endplate includes a receptacle in which the sealing disc is arranged.

12. The filter element of claim 11, wherein the first endplate opening is disposed within the receptacle.

13. The filter element of claim 11, wherein:
the first endplate further includes a plurality of latches via which the support structure is releasably connectable to a cover of the filter housing, the plurality of latches configured to releasably engage a plurality of complimentary mating formations of the cover; and
the plurality of latches are arranged circumferentially around the receptacle.

14. The filter element of claim 13, wherein:
the first endplate further includes an annular elevation extending circumferentially around the first endplate opening and disposed radially spaced apart from the first endplate opening;
the annular elevation defines an outer circumferential boundary of the receptacle; and
the plurality of latches project axially from the annular elevation.

15. The filter element of claim 13, wherein the plurality of latches each include a projection and a tab projecting radially inward from the projection.

16. The filter element of claim 1, wherein the second endplate includes a tubular extension configured to be received in and sealingly engage an annular collar of the filter housing, the tubular extension projecting axially from the second endplate and extending circumferentially around the second endplate opening.

17. The filter element of claim 16, wherein the tubular extension includes a sealing elevation projecting radially outward from and extending circumferentially around the tubular extension.

18. A filter element, comprising:
a support structure including a first endplate, a second endplate, and an interior tube extending between and connecting the first endplate and the second endplate;
the first endplate including:
a first endplate opening configured to receive a standpipe of a cover of a filter housing; and
a plurality of latches via which the support structure is releasably connectable to the cover of the filter housing;
the second endplate including:
a second endplate opening; and
a tubular extension configured to be received in and sealingly engage an annular collar of a housing base of the filter housing;
the interior tube defining an axial passageway extending between the first endplate and the second endplate;
a filter material arranged on the support structure between the first endplate and the second endplate and extending circumferentially around the interior tube; and
a fleece sealing disc arranged on and connected to the first endplate, the fleece sealing disc having a disc opening configured to receive the standpipe of the filter housing when the support structure is connected to the cover;
wherein the fleece sealing disc is deformable via the standpipe such that, when the support structure is connected to the cover, a deformed portion of the fleece sealing disc extends axially and is disposed radially between and in sealing contact with the first endplate and the standpipe.

19. The filter element of claim 18, wherein, prior to deformation, the fleece sealing disc at least partially covers the first endplate opening.

20. The filter element of claim 18, wherein the disc opening, the first endplate opening, the second endplate opening, and the axial passageway are at least partially aligned with one another in an axial direction.
